(19) United States
(12) Patent Application Publication
(10) Pub. No.: US 2025/0249583 A1
(43) Pub. Date: Aug. 7, 2025

(54) GENERALIST COMBINATIONAL OPTIMIZATION AGENT LEARNER

(71) Applicant: NAVER CORPORATION, Gyeonggi-do (KR)

(72) Inventors: Darko DRAKULIC, Grenoble (FR); Sofia MICHEL, Saint Ismier (FR); Jean-Marc ANDREOLI, Meylan (FR)

(73) Assignee: NAVER CORPORATION, Gyeonggi-do (KR)

(21) Appl. No.: 18/983,924

(22) Filed: Dec. 17, 2024

(30) Foreign Application Priority Data
Feb. 1, 2024 (EP) 24155250.4

(51) Int. Cl. B25J 9/16

(52) U.S. Cl. CPC B25J 9/1664; B25J 9/163

(57) ABSTRACT

A method for robot navigation includes: receiving a backbone neural network, the backbone neural network trained to solve a set of autonomous navigation tasks including a first autonomous navigation task, where the first autonomous navigation task includes optimizing a first path visiting a first number of first locations when considering first path costs; receiving a second autonomous navigation task, where the second autonomous navigation task includes optimizing a second path visiting a second number of second locations when considering second path costs, where the second locations are locations in an environment of an autonomous machine, where the second number is different from the first number; configuring adapter layers for the backbone neural network for forming a neural network pipeline; and feeding the second locations and the second path costs to the neural network pipeline and determining a path for the autonomous machine based on an output.

### CROSS-REFERENCE TO RELATED APPLICATIONS

This application claims the benefit of European Application No. EP24155250.4, filed on Feb. 1, 2024. The entire disclosure of the application referenced above is incorporated herein by reference.

### FIELD

This invention relates to robot navigation (e.g., autonomous machine or vehicle navigation), more particularly, to a neural network approach for robot navigation tasks (e.g., autonomous machine or vehicle navigation tasks) that involve combinatorial optimization.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In automation settings, autonomous machines, such as robots, may be tasked with visiting a number of locations while carrying payloads from place to place. For efficient robot navigation, the robot's trajectory is optimized while paying due consideration to various requirements such as maximum payload, maximal distance of travel before recharging, and time constraints. Such trajectory optimization may involve combinatorial optimization and may be a hard computational problem.

Exact solvers and approximation algorithms may provide optimality or approximation guarantees, respectively, but may not scale to real-world applications. Hence, trajectory optimization may involve diverse heuristic algorithms that generally produce good quality solutions and are fast. However, strong heuristic algorithms may be problem-specific, so that for each class of combinatorial optimization problem a specific heuristic may be chosen.

Neural constructive heuristics may be applied successfully to a variety of combinatorial optimization problems, including routing, scheduling, and graph problems. These may involve training separate models for each type of navigation problem.

Hybrid models may be used, where neural models are improved with different techniques like beam search, simulation-guided beam search, or active search. However, these may introduce additional computational expense.

### SUMMARY

In a feature, methods and systems for addressing robot navigation problems that include combinatorial optimization are proposed. The disclosed approach involves using a single deep neural network architecture to learn heuristics for addressing multiple navigation problems. The proposed approach allows large parameter sharing across several combinatorial optimization tasks.

Accordingly, a method for robot navigation is disclosed. The method includes receiving a backbone neural network, the backbone neural network having been trained to solve a set of robot navigation tasks including a first robot navigation task, where the first robot navigation task includes optimizing a first path visiting a first number of first locations when considering first path costs. The method further includes receiving a second robot navigation task, where the second robot navigation task includes optimizing a second path visiting a second number of second locations when considering second path costs. The second locations may particularly be locations in an environment of an autonomous machine, and the second number may be different from the first number, e.g., larger (e.g., by at least a predetermined amount) than the first number. The method further includes configuring adapter layers for the backbone neural network for forming a neural network pipeline, where the adapter layers include a node adapter, an edge adapter, and an output adapter, where the node adapter is configured to receive the second locations and providing a representation of the second locations to the backbone neural network, where the edge adapter is configured to receive the second path costs and providing a representation of the second path costs to the backbone neural network, and where the output adapter is configured to receive an intermediate solution of the second robot navigation task generated by the backbone neural network and for generating an output of the pipeline. The method also includes feeding the second locations and the second path costs to the neural network pipeline to determine a path for the autonomous machine based on the output.

According to an feature, the method further includes instructing the autonomous machine to move in the environment and the autonomous machine moving in/navigating the environment in accordance with the determined path.

According to features, the feeding the second locations and the second path costs to the neural network pipeline includes iterating the neural network pipeline for the second number of times, where at each iteration the output selects a next location of the second locations. Further, instructing the autonomous machine to move in the environment in accordance with the determined path may include, in response to completing a first iteration of the neural network pipeline, instructing the autonomous machine to start moving to the location selected in the first iteration of the neural network pipeline.

According to other features, the first path costs are according to an Euclidean metric for distances between the first locations, where the second path costs do not conform to any Euclidean metric.

According to yet other features, the first robot navigation task is an instance of a first combinatorial optimization problem, and the second robot navigation task is an instance of a second combinatorial optimization problem different from the first combinatorial optimization problem. The method may further include performing few-shot training of the node adapter, the edge adapter, and the output adapter to adjust the neural network pipeline to solve the second robot navigation task. In particular embodiments, while performing the few-shot training, parameters of the backbone neural network are frozen, where the performance of the few-shot (e.g., less than a predetermined number) training is based on imitation learning based on an algorithm for solving instances of the second combinatorial optimization problem or is based on reinforcement learning.

According to specific features, the second combinatorial optimization problem is the Maximum Coverage Location Problem.

Moreover, a method of training neural network pipeline for robot navigation is disclosed, the method including generating a plurality of training data sets, where each training data set corresponds to a robot navigation task of a plurality of robot navigation tasks. The generation of a training data set of the plurality of training data sets includes generating a number of training samples of the respective robot navigation task and solving the training samples by an algorithm for the respective robot navigation task. The method further includes training a plurality of neural network pipelines with the plurality of training data sets, where all neural network pipelines share a backbone neural network, where each neural network pipeline further includes a task-specific node adapter, a task-specific edge adapter, and a task-specific output adapter.

According to an aspect, the backbone neural network includes a predefined number of layers, where each layer comprises a mixed-score self-attention block, where the mixed-score self-attention block is configured to combine a node representation, a mask, and an edge representation, where the mask is provided by a masking block and the edge representation is provided by the task-specific edge adapter.

In addition, a computer-readable medium is disclosed, the computer-readable medium including instructions that, when executed by a processing unit, cause the processing unit to perform one of the disclosed methods.

Further, an autonomous machine is disclosed, the machine including position sensors, one or more propulsion devices (e.g., electric motors), one or more processors, and memory connected to the one or more processors. The memory stores a plurality of trained neural network pipelines corresponding to a plurality of machine navigation tasks (also referred to herein as robot navigation tasks), where the trained neural network pipeline includes a shared backbone neural network and task-specific adapter layers. The position sensors may be configured to provide a current position of the machine to the processor(s).

In particular embodiments, the autonomous machine may be tasked with visiting a plurality of locations before returning to a depot. The processing unit may be configured to provide instructions to the propulsion device(s) for moving the machine along a motion path or flight path as determined in accordance with the embodiments described above. In further embodiments, the machine may further include one or more components configured to transport a payload, and the machine may be tasked with one or more of delivering a plurality of payloads from a depot to a plurality of locations, delivering a plurality of payloads from a depot to a plurality of locations, where for each location, one or more of the payloads has to be delivered within a specific time window, transporting a plurality of payloads from a plurality of locations to a depot, and selecting one or more payloads from a plurality of payloads to maximize a metric value of the one or more payloads while taking into account a maximum load of the machine.

In a feature, a method for robot navigation includes: receiving a backbone neural network, the backbone neural network trained to solve a set of autonomous navigation tasks including a first autonomous navigation task, where the first autonomous navigation task includes optimizing a first path visiting a first number of first locations when considering first path costs; receiving a second autonomous navigation task, where the second autonomous navigation task includes optimizing a second path visiting a second number of second locations when considering second path costs, where the second locations are locations in an environment of an autonomous machine, where the second number is different from the first number; configuring adapter layers for the backbone neural network for forming a neural network pipeline, where the adapter layers comprise a node adapter, an edge adapter and an output adapter, where the node adapter is configured to receive the second locations and provide a representation of the second locations to the backbone neural network, where the edge adapter is configured to receive the second path costs and provide a representation of the second path costs to the backbone neural network, and where the output adapter is configured to receive an intermediate solution of the second autonomous navigation task generated by the backbone neural network and to generating an output of the pipeline; and feeding the second locations and the second path costs to the neural network pipeline and determining a path for the autonomous machine based on the output.

In further features, the method further includes instructing the autonomous machine to move in the environment in accordance with the determined path.

In further features, the method further includes, by the autonomous machine, autonomously following the path and navigating the environment.

In further features, the feeding the second locations and the second path costs to the neural network pipeline comprises iterating the neural network pipeline for the second number of times, where at each iteration the output adapter selects a next location of the second locations.

In further features, the instructing the autonomous machine to move in the environment in accordance with the determined path includes, in response to completing a first iteration of the neural network pipeline, instructing the autonomous machine to start moving to the next location selected in the first iteration of the neural network pipeline.

In further features, the first path costs are according to an Euclidean metric for distances between the first locations, where the second path costs do not conform to any Euclidean metric.

In further features, the first autonomous navigation task is an instance of a first combinatorial optimization problem, and where the second autonomous navigation task is an instance of a second combinatorial optimization problem.

In further features, the second combinatorial optimization problem is different from the first combinatorial optimization problem.

In further features, the configuring adapter layers further includes: performing few-shot training of the node adapter, the edge adapter, and the output adapter and adjusting the neural network pipeline based on solving the second autonomous navigation task.

In further features, the method further includes freezing the parameters of the backbone neural network during the performing the few-shot training.

In further features, the performing the few-shot training is based on imitation learning based on solving instances of the second combinatorial optimization problem.

In further features, the performing the few-shot training is based on reinforcement learning.

In further features, the second combinatorial optimization problem is the Maximum Coverage Location Problem.

In a feature, a system for robot navigation includes: one or more processors; and memory including code that, when executed by the one or more processors, perform to: receive a backbone neural network, the backbone neural network trained to solve a set of autonomous navigation tasks including a first autonomous navigation task, where the first autonomous navigation task includes optimizing a first path visiting a first number of first locations when considering first path costs; receive a second autonomous navigation task, where the second autonomous navigation task includes optimizing a second path visiting a second number of second locations when considering second path costs, where the second locations are locations in an environment of an autonomous machine, where the second number is different from the first number; configure adapter layers for the backbone neural network for forming a neural network pipeline, where the adapter layers include a node adapter, an edge adapter and an output adapter, where the node adapter is configured to receive the second locations and provide a representation of the second locations to the backbone neural network, where the edge adapter is configured to receive the second path costs and provide a representation of the second path costs to the backbone neural network, and where the output adapter is configured to receive an intermediate solution of the second autonomous navigation task generated by the backbone neural network and to generating an output of the pipeline; and feed the second locations and the second path costs to the neural network pipeline and determine a path for the autonomous machine based on the output.

In further features, the method further includes the autonomous machine configured to autonomously follow the path and navigate the environment.

In a feature, a method of training neural network pipelines for robot navigation includes: generating a plurality of training data sets, where each training data set corresponds to an autonomous navigation task of a plurality of autonomous navigation tasks, where the generating a training data set of the plurality of training data sets includes: generating a number of training samples of the respective autonomous navigation task; and solving the training samples for the respective autonomous navigation task; and training a plurality of neural network pipelines with the plurality of training data sets, where all neural network pipelines share a backbone neural network, where each neural network pipeline further comprises a task-specific node adapter, a task-specific edge adapter, and a task-specific output adapter.

In further features, the backbone neural network comprises a predetermined number of layers, where each layer comprises a mixed-score self-attention block.

In further features, the mixed-score self-attention block is configured to combine a node representation, a mask, and an edge representation.

In further features, the mask is provided by a masking block and the edge representation is provided by the task-specific edge adapter.

In a feature, an autonomous machine includes: position sensors; one or more propulsion devices; one or more processors; and memory that stores a plurality of trained neural network pipelines corresponding to a plurality of autonomous navigation tasks, where the trained neural network pipelines comprise a shared backbone neural network and task-specific adapter layers.

In further features, the autonomous navigation tasks include the autonomous machine autonomously traveling from a starting location, visiting a plurality of locations, and ending at an ending location.

In further features, the autonomous navigation tasks further include one or more of: delivering payloads to one or more locations; delivering the payloads to one or more locations within a predetermined time window; and selecting one or more payloads from a plurality of payloads based on maximizing a metric value of the one or more payloads while taking into account a maximum load of the autonomous machine.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 illustrates a neural network pipeline for robot navigation;

FIG. 2 illustrates a backbone neural network;

FIG. 3 illustrates a mixed score self-attention block employed in a backbone neural network;

FIG. 4 illustrates a method of training neural network pipelines for robot navigation;

FIG. 5 illustrates a method of configuring neural network pipelines for robot navigation;

FIG. 6 reproduces performance results of the disclosed model for the Maximum Covering Location Problem; and

FIG. 7 illustrates an example system in which the disclosed methods may be applied.

In the drawings, reference numbers may be reused to identify similar and/or identical elements.

### DETAILED DESCRIPTION

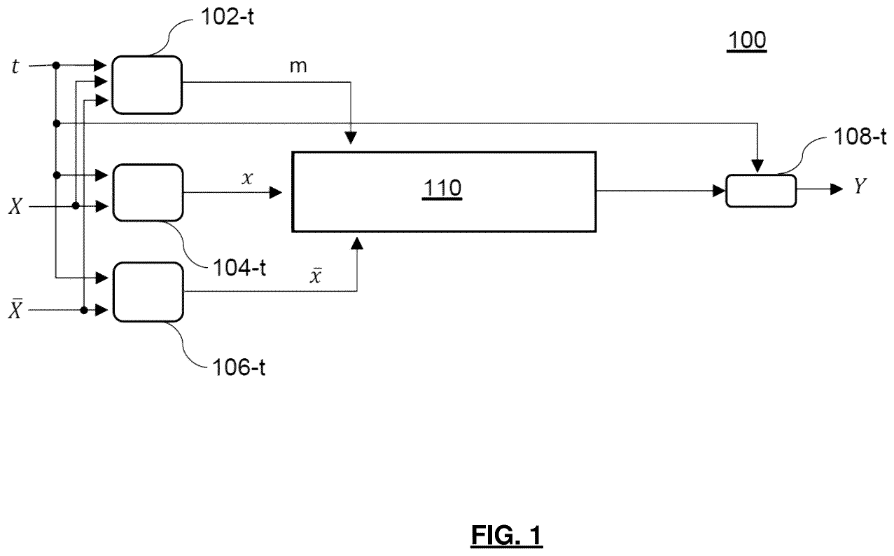

FIG. 1 illustrates a pipeline 100 of neural networks for solving a plurality of tasks t for robot trajectory optimization. Each task t falls under a type of combinatorial optimization problem. Such problems involve a set of N nodes, which may refer to or be locations. Technical properties of the task are assigned to features, which can be attached at node, edge, or task level.

In pipeline 100, task-specific node adapter 104-t and task-specific edge adapter 106-t feed their output to backbone neural network 110, which is shared by all tasks t. Backbone neural network 110 generates an intermediate representation of the solution of task t, which is translated to a solution of the task t by task-specific output adapter 108-t. An underlying assumption is that if the tasks are sufficiently similar, learning one task elicits implicit skills useful to other tasks, which are then leveraged by parameter sharing by virtue of backbone neural network 110. As explained in detail below, pipeline 100 is trained to imitate the results of oracle algorithms.

In pipeline 100, task t is represented by (X, X̅), where X is a matrix of shape [symbol] N, Fₜ [symbol] representing nodes. The number Fₜ is the dimension of feature vectors assigned to each node. It is assumed that each node has a node identifier, such as randomly assigned value between 0 and 1, so that Fₜ≥1, always. Node features may relate to the operations to be performed at that node, e.g., a demand of cargo at this node. Node features may also include global task features which are replicated at each node. For example, such node features may be a remaining payload capacity of the robot or a remaining distance that can be travelled before a next charging.

In pipeline 100, X is provided to node adapter 104-t. Node adapter 104-t is configured to map input X into a common embedding space, yielding a tensor of shape [symbol] N, D [symbol] , where D does not depend on t. Node adapter 104-t is hence specific to task t. The term X̅ is of shape [symbol] N, N, F̅ₜ [symbol] and represents edge features for N×N edges between the nodes, which may be or represent paths between locations. Edge features may represent costs of travelling along the edges. When no edge features are available for a task, F̅ₜ=0. In pipeline 100, X̅ is provided to edge adapter 106-t. Edge adapter 106-t is specific to task t and is configured to map input X̅ into a common embedding space, yielding a tensor of shape [symbol] N, N, D [symbol] , where D does not depend on t.

Backbone neural network 110 generates an intermediate representation of a solution of task t. The intermediate representation is provided to output adapter 108-t to be transformed to a task-specific solution. Concretely, output adapter 108-t generates a matrix Y of shape [symbol] N, Kₜ [symbol] , which forms an action score matrix predicted by the pipeline 100.

Masking block 102-t generates a mask employed for iterative construction of a solution to task t. Masking block 102-t is a parameter-free module which masks the last of the already visited nodes and the destination node. In the proposed approach, only the last of the already visited nodes and the non-visited nodes are used to determine the next node, which cannot be the last visited node nor the destination node, hence the need to mask these two nodes. Nodes which have already been visited in the robot path, except the last one, may simply be dropped altogether.

Pipeline 100 thereby achieves a stepwise construction procedure of a solution of task t by exploiting tail-recursivity of the combinatorial optimization problem. The claimed approach hence frames the combinatorial optimization problem as a deterministic Markov chain. Each partial solution of task t is obtained by a sequence of discrete construction steps, each according to a Markov decision problem. In particular, only a current state of already selected locations for the robot path are used for choosing the next position.

By sharing backbone neural network 110 among all tasks and employing lightweight task-specific neural networks 104-t and 106-t, and 108-t, pipeline 100 provides for a multi-task solution across many combinatorial optimization problems. With a high number of shared parameters, pipeline 100 is able to be fine-tuned to new tasks with little training expense. In particular, only the lightweight neural networks 104-t, 106-t, and 108-t are adjusted during fine-tuning for specific tasks. Significantly, adapters 104-t, 106-t, and 108-t are not intertwined into the weights of backbone neural network 110, but are completely separate from backbone neural network 110.

Task t can in particular be an instance of the traveling salesman problem, such that the objective is to find the shortest possible route that the robot can take to visit a given set of locations exactly once and return to its starting point. In this application, the travelling salesman problem is treated in a variant in which the origin and destination of the salesman are treated as distinct but, potentially, having the same coordinates. In the context of the present application, the traveling salesman problem is addressed even in a non-Euclidean context, where time or energy rather than distance is represented. Accordingly, when task t is an instance of the travelling salesman problem, the node features are a node identifier, a first binary value indicating whether the node is the origin, and a second binary value indicating whether the node is the destination. Hence, Fₜ=3 for instances of the travelling salesman problem. For edges, there is a feature holding the quantity which characterizes the contribution of the edge to the objective to minimize, e.g., distance, time, or energy so that F̅ₜ=1.

Task t may also be an instance of the orienteering problem that involves finding an optimal route to maximize scores of collected goods when visiting a set of locations under a maximal distance constraint. Task t may also be a knapsack problem, which involves selecting, e.g., as the payload of the robot, a subset of items from a given set while paying consideration to a maximum load of the robot.

Task t may also fall under combinatorial optimization problems which are relevant for fleets of machines (e.g., robots). For example, the task may relate to the capacitated vehicle routing problem with the objective to optimize delivery routes of a fleet of robots to a set of locations, while considering each robot's predetermined maximum (carrying) load. This problem can also be considered with time constraints so that for every location, there is a specified time window when a robot should be at the location along with a time to be spent at the location. According to yet another embodiment, the minimum vertex cover problem is covered, where a goal is to find the smallest set of vertices in a graph, such that each edge is incident to at least one of these vertices. In a weighted version of the minimum vertex cover problem, each vertex has an associated weight, and the goal is to select vertices with the minimum cumulated sum of weights while satisfying a vertex cover condition. Finally, task t can be an instance of the maximum coverage location problem. In this problem, a set of locations with associated weights and radius of coverage of each robot is given. A goal is then to find an optimal placement of robots on a subset of the locations that maximizes the total sum of the weights of the covered locations.

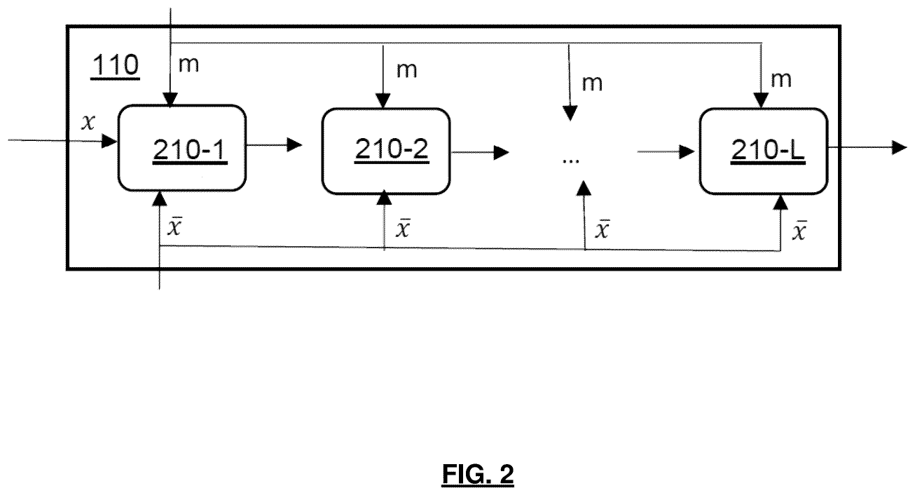

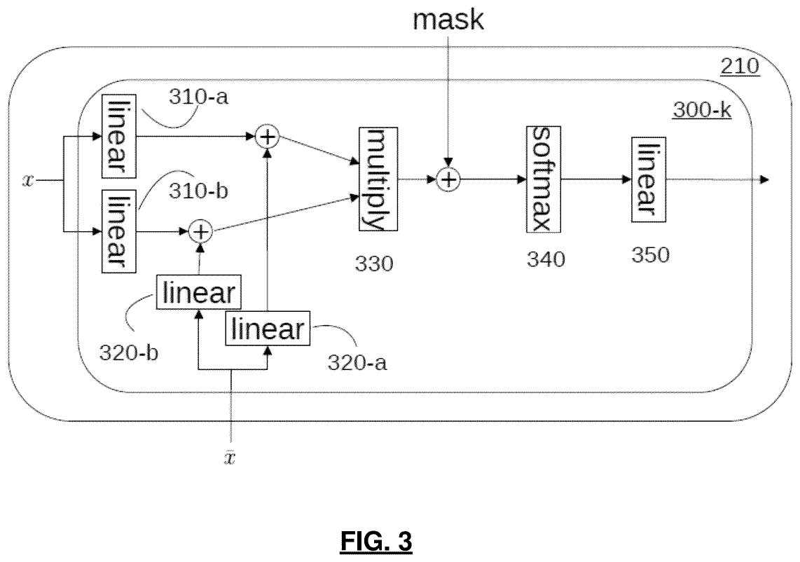

FIG. 2 illustrates a structure of backbone neural network 110. Backbone neural network 110 includes layers 210-1, . . . , 210-L. At the first layer 210-1, input from node adapter 104-t is received. Layer 210-1 is followed by layer 210-2 and further subsequent layers 210-3, . . . , until final layer 210-L. Each layer 210-1, . . . , 210-L receives a mask set by masking block 102-t, and output of the edge adapter 106-t. Each layer 210-1, . . . , 210-L combines these input features according to an attention mechanism, which will be explained below with reference to FIG. 3. Except for the different attention mechanism, layers 210-1, . . . , 210-L may be Transformer layers and have the Transformer architecture. Output of the final layer 210-L forms an intermediate solution of the task t, to be provided to output adapter 108-t. In embodiments, additional adapters in between layers 210-1, . . . , 210-L can be applied.

FIG. 3 illustrates a structure of a layer 210 of backbone neural network 110. Each of the layers may have the same architecture. Layer 210 has embedding dimensions D and D̅ and is based on the self-attention layer of the transformer (e.g., Vaswani et al. “Attention is all you need”, in: I. Guyon, U. V. Luxburg, S. Bengio, H. Wallach, R. Fergus, S. Vishwanathan, and R. Garnett, editors, Advances in Neural Information Processing Systems 30, pages 5998-6008, Curran Associates, Inc., 2017, which is incorporated herein in its entirety). However, instead of usual Transformer attention, a multi-head mixed score self-attention head 300-k may be employed. The mixed score self-attention head 300-k is one of several parallel attention heads 300-k, k=1, . . . , K forming a multi-head attention layer. Mixed score self-attention head 300-k takes three inputs, the node representation x of shape [symbol] N, D [symbol] , a mask m of shape [symbol] N, N [symbol] , and an edge representation x of shape [symbol] N, N, D̅ [symbol] . The mixed score self-attention block 300-k outputs a new node representation of shape [symbol] N, D/K [symbol] . The behavior varies the standard multi-head self-attention based on x and the mask m, in which x̅ is integrated.

In more detail, linear layers 310-a, 310-b, 320-a, and 320-b are included. The action of a mixed score self-attention blocks 300-k can be represented as

$${A}_{k} = soft {max}_{col} ( {S}_{k} + mask ) \qquad ( 1 )$$

$${( {S}_{k} )}_{mn} = ( {x}_{m} {Φ}_{k} + {\overline{x}}_{mn} {\overline{Φ}}_{k} ) {( {x}_{n} {Ψ}_{k} + {\overline{x}}_{mn} {\overline{Ψ}}_{k} )}_{T} \qquad ( 2 )$$

The addition performed by the adders of FIG. 3 are illustrated by the + of Eq. (2). As is evident from Eq. (1), the attention matrix Aₖ is obtained as by taking the column-wise softmax of an attention score matrix Sₖ of shape [symbol] N,N [symbol] summed with the mask. Mask values may be either 0 or −∞. In attention, the score (Sₖ)ₘₙ for nodes m, n is the scalar product of a key vector xₘφₖ and a query vector xₙψₖ obtained by linear projections φₖ, ψₖ applied element-wise to x. In our mixed attention described by Eq. (2), the key and query vectors may be modified to incorporate edge information x̅: the key vector becomes xₘφₖ+x̅ₘₙφ̅ₖ and the query vector becomes xₙψₖ+x̅ₘₙψ̅ₖ, where φ̅ₖ, ψ̅ₖ are additional linear projections applied edge-wise to x̅.

In various circumstances, the nodes are not homogeneous but clustered in different types. For example, some nodes may represent tasks to be performed by agents (e.g., robots or humans) while other nodes may represent the agents which perform the tasks. While this type information may be injected into the embeddings of each node by the input adapters, this information may additionally be injected into the computation of the mixed attention. This has been shown experimentally beneficial. For example, the softmax block 340 may be replaced with a multi-type softmax version (e.g., MTsoftmax), which performs a separate softmax operation on each cluster of nodes of the same type. In the example, that would mean a separate softmax for agents and for tasks. This can be represented as

$$MTsoft max ( v ) = {\sum }_{c = 1}^{c} {w}_{c} soft max ( v + {E}_{c} )$$

where v is the input vector indexed by all the nodes, and the different types of nodes are denoted c=1:C. Vector Ec denotes the log-binary mask corresponding to type c, i.e. having value 0 for nodes of type c and −∞ for all the other nodes. The scalar coefficients w_{1:C} represent the weights of the different types (positive numbers summing to 1). If all types are deemed equally important, w_{c} may be set equal to 1c.

The output of all parallel mixed score self-attention blocks 300-k is summed, such as according to the equation:

$$y = {\sum }_{k} {A}_{k}^{T} \times {θ}_{k} \qquad ( 3 )$$

θk corresponds to projection block 350.

As is evident from Eq. (1)-(2), the attention matrix Aₖ is obtained as in the standard case by taking the column-wise softmax of an attention score matrix Āₖ of shape [symbol] N, N [symbol] summed with the mask m. Mask values m are either 0 or −∞. But whereas the standard Āₖ is directly given by the bilinear product xΛₖx^{T}, mixed score self-attention block 300-k first stacks xΛₖx^{T} with the edge representation x̅ to obtain a tensor of shape [symbol] N, N, D̅+1 [symbol] , which is then passed edgewise to trainable element-wise function block 330, represented by function ƒ which is parametrized by μₖ. Trainable element-wise function block 330 may, for example, be a perceptron (e.g., MLP) with parameters μₖ. Trainable element-wise function block 330 has input size D̅+1 and parameters μₖ. Thus, the score matrix Āₖ generated by element-wise function block 330 is again of shape [symbol] N, N [symbol] , but incorporates the edge information x̅.

Hence, each mixed score self-attention head 300-k has five trainable parameters φₖ, ψₖ, φₖ, ψₖ, θₖ. Parameters θₖ, ψₖ may be matrices of size [symbol] D, d [symbol] , parameters φ̅ₖψ̅ₖ may be matrices of size [symbol] D̅, d [symbol] , and parameter θₖ may be a matrix of size [symbol] d, D [symbol] , where d is a common dimension usually taken as D/K as in attention.

According to embodiments, task-specific greedy heuristics are applied to avoid the quadratic complexity bottleneck of attention matrices. Thus, instead of presenting all the N nodes of the input instance to the model, the heuristic selects a priori a subset of n most promising ones. Thus, the attention matrices may never exceed size n×n, even when N×N would be unmanageable. For the travelling salesman problem, for example, only the origin, destination, and 100 nearest neighbors to the origin are presented. Such pre-selection criteria can be defined for each task, as explained below.

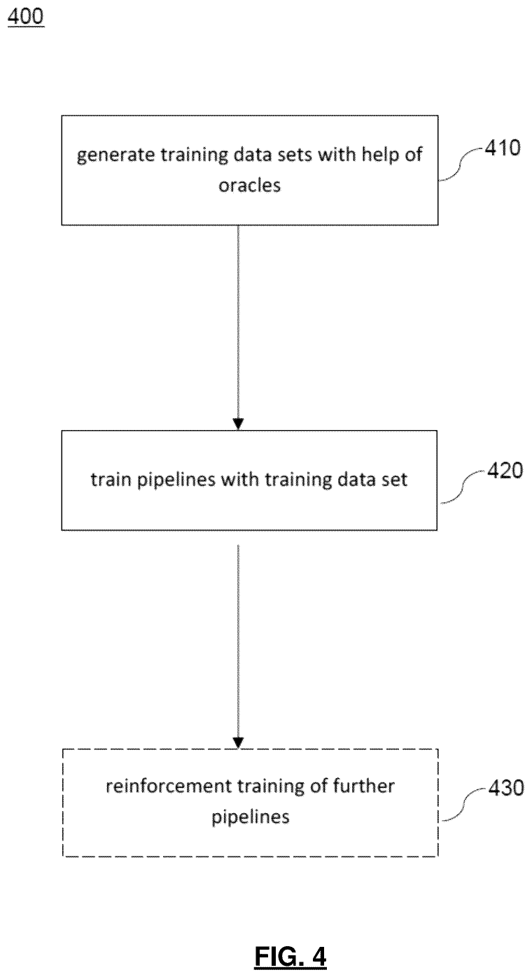

FIG. 4 illustrates a flowchart of a training method 400 of neural network pipelines for robot navigation.

Method 400 includes 410 involving generating a plurality of training data sets, where each training data set corresponds to an associated robot navigation task, where the robot navigation task is a tail-recursive path optimization problem. 410 may include generating a number of instances of the associated robot navigation task and solving each instance of the associated robot navigation tasks by an oracle, e.g., a specific algorithm for the associated robot navigation task.

420 includes training neural network pipelines including task-specific node input adapters, task-specific edge input adapters, the backbone neural network, and task-specific output adapters with the training data sets. Specifically, each training data set is employed for training a pipeline specific for the associated robot navigation task, while all the neural network pipelines share the backbone neural network. 410 and 420 hence achieve imitation learning based on the oracle for the associated robot navigation tasks. The backbone neural network is hence trained for different tasks by virtue of task-specific adapters. Because the robot navigation tasks are sufficiently similar, training the neural network pipelines on the tasks has a synergistic effect on the backbone neural network because learning one task elicits implicit skills useful to other tasks.

Alternatively or additionally, when training for robot navigation tasks for which no viable oracle algorithm is available, method 400 may include 430 of reinforcement training of the neural network pipelines for these tasks. To apply reinforcement training, methods for learning Markov Decision Problems may be such as DQN or policy gradients may be used, as explained in Sutton and Barto, “Reinforcement Learning: An Introduction”, MIT Press, 2018, which is incorporated herein in its entirety. Specifically, applying reinforcement training may be advantageous to train the pipelines for specific problem variants for which the available oracle algorithms are not adapted.

As a result of method 400, a backbone neural network for multi-task robot navigation is obtained. The backbone neural network is ready to be fine-tuned on the fly to a specific robot navigation task.

In an embodiment, the model is implemented with 8 layers, an embedding size of 96, and a feed-forward dimension of 512. The attention block may be implemented with 6 attention heads. Mixing with edge features may be performed through an MLP block with a hidden size of 16. The node and edge adapters may be implemented as MLP blocks with 4 hidden dimensions.

TABLE 1

| | (A)TSP | (A)CVRP | (A)CVRPTW | OP | KP | MWVC | MCLP |
|---|---|---|---|---|---|---|---|
| Node features | — | demand | demand, | price | price, | weight | weight |
| | | | time window, | | weight | | |
| | | | service time | | | | |
| Edge features | (a)symmetric | (a)symmetric | (a)symmetric | symmetric | — | adjacency | symmetric |
| | distance | distance | distance | distance | | matrix | distance |
| | matrix | matrix | matrix | matrix | | | matrix |
| Instance features | — | vehicle | vehicle | max. tour | knapsack | — | number of |
| | | capacity | capacity | length | capacity | | facilities, |
| | | | | | | | radius of |
| | | | | | | | coverage |
| Solution | sequence of | set of tours | set of tours | tour | set of nodes | set of nodes | set of nodes |
| | nodes (tour) | | | | | | |

| Oracle | Concorde (LKH3) | LKH3 (HOS) | HOS | EA4OP | ORTools | FastWVC | Pulp/CBC |
|---|---|---|---|---|---|---|---|
| AM | Euclidean | Euclidean | | ✓ | | | |
| POMO | Euclidean | Euclidean | | | ✓ | | |
| MDAM | Euclidean | Euclidean | | ✓ | | | |
| SymNCO | Euclidean | Euclidean | | ✓ | | | |
| BQNCO | Euclidean | Euclidean | | | ✓ | | |
| S2V-DQN | Euclidean | | | | | | non-weighted |
| MatNet | ✓ | | | | | | |
| GOALₒᵤᵣₛ | ✓ | ✓ | ✓ | ✓ | ✓ | ✓ | ✓ |

The example model may be trained for the seven combinatorial optimization problems listed in Table 1, the Traveling Salesman Problem (TSP), the Capacitated Vehicle Routing Problem (CVRP), CVRP with time windows (CVRPTW), the Orienteering Problem (OP), the Knapsack Problem (KP), the Minimum Weighted Vertex Covering Problem (MWVC), and the Maximum Covering Location Problem (MCLP). For the problems TSP, CVRP, and CVRPTW asymmetric variants ATSP, ACVRP, and ACVRPTW are additionally considered, in which edge information is not in accordance with an Euclidean metric. In such cases, the edge features according to an Euclidean distance matrix were further augmented with a matrix of random values between 0 and 0.1.

In more detail, for CVRP, the node features may be a random node index, a Boolean value “is origin”, a Boolean value “is destination”, a demand, and a remaining capacity. In CVRP, visits to the depot are represented as a “via point”. The pipeline is trained to select a pair of a single node and an indicator whether it should be reached via the depot or directly. For CVRPTW, the node features may in addition include service time, time window start, time window end and departure time.

For OP, node features may be a random node index, Boolean values “is origin” and “is destination”, a value, and a remaining tour length. For TSP, CVRP, CVRPTW, and OP, the edge features may be according to an Euclidean distance, and a node preselection criterion may be based on the Euclidean distance from the origin. For KP, the node features may include a random node index, a weight, a value, and a remaining capacity, and edges may be defined by an adjacency matrix value. The node preselection criterion may be based on a value over weight ratio. For MWVC, node features may include a random node index and a weight, the edges may be defined by an adjacency matrix value, and a node preselection criterion may be chosen as a weight over node degree ratio. For MCLP, node features may include a random node index, a weight, and a radius, and the edges may be defined by an Euclidean distance, while the node preselection criterion may be based on weight.

The example model may be trained using alternating batches for each problem, such as using cross-entropy loss. For TSP, CVRP, CVRPTW, and OP, single-class cross entropy loss was employed, while for KP and MWVC multi-class cross entropy loss was employed. Following the approach of Drakulic et al. “BQ-NCO: Bisimulation Quotienting for Generalizable Neural Combinatorial Optimization”, arxiv: 2301.03313, 2023, suffix sub-problems are sampled for each instance. Drakulic et al., 2023 is included herewith in its entirety. For optimization, the Adam optimizer with an initial learning rate of 0.0005 and a decay rate every 20th epochs may be used. The total training process spanned approximately 400 epochs. For all problems, training batches were sized 256 samples.

Significantly, as indicated in Table 1, no other neural combinatorial optimization model may handle all of the combinatorial optimization problems listed in Table 1 by a single approach.

Table 1 also lists the algorithms (also called oracles) used for imitation training. These algorithms include Concorde (Applegate et al. “Concorde TSP Solver”, 2015), LKH (Helsgaun, “An Extension of the Lin-Kernighan-Helsgaun TSP Solver for Constrained Traveling Salesman and Vehicle Routing Problems”, Technical report, Roskilde University, 2017), HGS (Vidal, “Hybrid Genetic Search for the CVRP: Open-source Implementation and SWAP* Neighborhood”, Computers & Operations Research, 140:105643, 2022), EA4OP (Kobeaga et al. “An Efficient Evolutionary Algorithm for the Orienteering Problem”, Computers & Operations Research, 90:42-59, 2018), ORTools (Didier et al. “OR-Tools: Vehicle Routing Solver: a Generic Constraint-Programming Solver with Heuristic Search for Routing Problems”, Google research, 2023), Fast-WVC (Cai et al. “Towards faster local search for minimum weight vertex cover on massive graphs”, Information Sciences, volume 471, 2019, pages 64-79, https://github.com/kjcm150/fastwvc), and Coin-or/cbc: Release Releases/2.10.11 (https://zenodo.org/records/10041724, John Forrest, et al. 2023).

The bottom rows of Table 1 list other models for solving some combinatorial optimization problems. The other models include AM (Kool et al. “Attention, Learn to Solve Routing Problems!”, in: International Conference on Learning Representations, ICLR, 2019), MDAM (Xin et al. “Multi-Decoder Attention Model with Embedding Glimpse for Solving Vehicle Routing Problems”, Proceedings of the AAAI Conference on Artificial Intelligence, 35 (13): 12042-12049), POMO (Kwon et al. “POMO: Policy Optimization with Multiple Optima for Reinforcement Learning”, in: NeurIPS 2020), Sym-NCO (Kim et al. Sym-NCO: “Leveraging Symmetricity for Neural Combinatorial Optimization”, in: NeurIPS 2022) and BQ-NCO (Drakulic et al. 2023, cited above).

As indicated by the checkmarks, none of the other models is capable of solving all tasks addressed by the disclosed model. Further, for the problems TSP, CVRP, and CVRPTW, most models are incapable of considering non-Euclidean settings. Moreover, all other models are trained for a single-task. It is to be noted that there seems to be no neural combinatorial optimization approach.

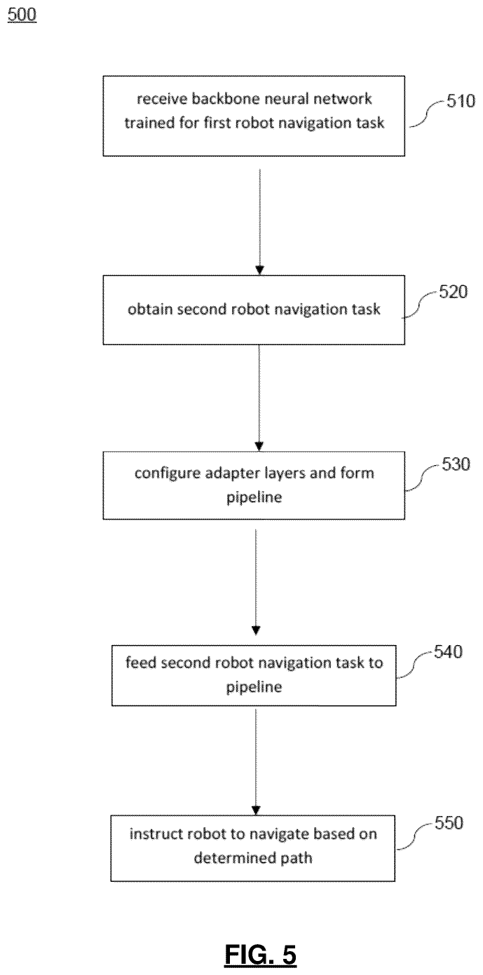

FIG. 5 illustrates a flowchart of a method 500 for robot navigation (e.g., machine navigation). Method 500 may for example be performed by a robot that may be part of a fleet of robots configured to perform tasks in a particular environment, such as collecting and moving objects from place to place. For example, the robots may be deployed in an automatic warehouse, a plant, or an automated indoor farm and may be tasked with carrying payloads in such environments.

Method 500 includes 510 including receiving backbone neural network 110. Backbone neural network 110 has been trained together with dedicated adapters as explained above in the context of solving a set of robot navigation tasks (machine navigation tasks).

Method 500 includes 520 including obtaining a robot navigation task. The robot navigation task may include optimizing a path visiting a number of locations of an environment of the robot, when considering path costs for paths between the locations. The number of locations may be different to the number of locations employed when training the backbone neural network 110. The robot navigation task may also differ in other respects from robot navigation tasks on which the backbone neural network 110 has been trained, e.g., in involving path cost (e.g., value) which is not according to an Euclidean metric. Considering non-Euclidean cost is very relevant in real-world situations in which e.g., a road has obstacles in one direction but not the other direction. In real-world situations, in particular, the path cost often do not satisfy the triangle inequality.

Method 500 further includes 530 including configuring adapter layers for the backbone neural network 110 to form a neural network pipeline. This may be performed by a configuration module, such as provided by the one or more processors and memory including instructions. For example, adapter layers for the received robot navigation task may be selected from a plurality of adapter layers according to a type of the robot navigation task. Further, the selected adapter layers, including a node adapter, an edge adapter and an output adapter may be adjusted based on the number of locations of the received task. Further, the selected adapter layers may be adjusted to consider a maximal payload or a maximal distance of travel for the robot. 530 may also include few-shot training of the selected adapter layers (e.g., by a training module) when the robot navigation task is an instance of a combinatorial optimization problem on which the backbone neural network 110 has not been trained. Few-shot training may involve training only the adapter layers while keeping parameters of the backbone neural network 110 frozen.

Method 500 includes 540 including feeding the robot navigation task to a pipeline comprising the adjusted node adapter, edge adapter and adjusted output adapter (e.g., implemented in a planner module). After a first iteration of the pipeline, a first location for robot navigation is determined. In a second iteration, the first location is masked to determine a second location. Over a plurality of iterations, the whole robot path visiting all locations defined in the task is obtained. The planner module may determine the path.

Method 500 may include 550 including instructing the robot to move in accordance with the determined robot path. The robot then automatically moves and actuates according to the path to follow the path, visit the locations, and perform the task. In embodiments, the robot can be instructed to navigate to the first location as soon as the first iteration of the pipeline is completed. In various implementations, 540 and 550 are performed concurrently.

TABLE 2

| | | Test (128 instances) | | | Generalization to larger size (128 instances) | | | | | | | | |
|---|---|---|---|---|---|---|---|---|---|---|---|---|---|
| | | N = 100 | | | N = 200 | | | N = 500 | | | N = 1000 | | |
| | | opt. gap | time | | opt. gap | time | | opt. gap | time | | opt gap | time | |
| TSP | Concorde | 0.00% | 29 | s | 0.00% | 2 | m | 0.00% | 40 | m | 0.00% | 2.5 | h |
| | OR-Tools | 3.76% | 50 | s | 4.52% | 4 | m | 4.89% | 31 | m | 5.02% | 2.4 | h |
| | AM greedy | 4.33% | <1 | s | 8.30% | <1 | s | 20.99% | <1 | s | 34.74% | <1 | s |
| | MDAM greedy | 2.21% | 1.2 | s | 5.86% | 5.4 | s | 18.21% | 20.9 | s | 32.12% | 20.9 | s |
| | POMO no aug | 0.37% | 1.1 | s | 2.21% | 1.6 | s | 24.32% | 28.4 | s | 42.3% | 1.1 | m |
| | Sym-NCO greedy | 1.19% | 3 | s | 4.75% | <1 | s | 29.97% | 3 | s | 46.05% | 1.2 | m |
| | BQ-NCO greedy | 0.59% | 2 | s | 0.79% | 5 | s | 1.42% | 1.3 | m | 2.33% | 7.2 | m |
| | GOAL greedy | 1.29% | 3.1 | s | 1.99% | 8.5 | s | 4.00% | 27 | s | 6.26% | 1.0 | m |
| CVRP | LKH | 0.00% | 15.3 | h | 0.00% | 30 | m | 0.00% | 1.3 | h | 0.00% | 2.8 | h |
| | HGS | −0.51% | 15.3 | h | −1.02% | 30 | m | −1.25% | 1.3 | h | −1.10% | 2.8 | h |
| | OR-Tools | 9.62% | 11.7 | m | 10.70% | 3 | m | 11.40% | 18 | m | 13.56% | 43 | m |
| | AM greedy | 7.11% | <1 | s | 10.16% | <1 | s | 17.2% | <1 | s | 72.95% | 2.1 | s |
| | MDAM greedy | 4.84% | 1.1 | s | 7.54% | 6.5 | s | 12.94% | 24.7 | s | 32.25% | 1.5 | m |
| | POMO no aug | 1.21% | 1.1 | s | 5.94% | 6.6 | s | 31.36% | 32.4 | s | 284.58% | 1.4 | m |
| | Sym-NCO greedy | 3.33% | <1 | s | 8.42% | 3 | s | 37.58% | 54 | s | 481.53% | 8.8 | m |
| | BQ-NCO greedy | 4.83% | 1 | s | 3.72% | 5 | s | 3.42% | 1.3 | m | 6.81% | 7.2 | m |
| | GOAL greedy | 4.03% | 2.8 | s | 3.95% | 8.5 | s | 4.62% | 29.4 | s | 8.27% | 1.0 | m |
| CVRPTW | HGS {m | 0.00% | 2.1 | h | 0.00% | 2.1 | h | 0.00% | 2.1 | h | 0.00% | 2.1 | h |
| | HGS 1s | 108/128 | 2.1 | m | 14/128 | 2.1 | m | 0/128 | 2.1 | m | 0/128 | 2.1 | m |
| | GOAL greedy | 7.35% | 2.8 | s | 11.32% | 8.8 | s | 14.36% | 31 | s | 12.76% | 1.1 | m |
| OP | EA4OP | 0.00% | 1.1 | m | 0.00% | 3 | m | 0.00% | 11 | m | 0.00% | 45 | m |
| | AM greedy | 5.35% | 5 | s | 11.05% | <1 | s | 22.29% | <1 | s | 30.73% | <1 | s |
| | MDAM greedy | 2.88% | 16 | s | 5.55% | <1 | s | 18.31% | 4 | s | 30.05% | 15 | s |
| | SymNCO greedy | 2.03% | 2 | s | 6.60% | <1 | s | 19.81% | 1 | s | 31.79% | 1.2 | m |
| | GOAL greedy | 0.66% | 2.4 | s | 2.45% | 9.8 | s | 5.09% | 16.2 | s | 10.83% | 32.5 | s |
| KP | ORTools | 0.00% | <1 | s | 0.00% | <1 | s | 0.00% | <1 | s | 0.00% | <1 | s |
| | POMO single traj. | 0.19% | <1 | s | 0.50% | 1 | s | 6.41% | 31.2 | s | 5.34% | 1.2 | m |
| | BQ-NCO greedy | 0.10% | 2.3 | s | 0.14% | 6.4 | s | 0.74% | 7.5 | s | 0.92% | 13.1 | s |
| | GOAL greedy | 0.15% | 2.3 | s | 1.35% | 5.9 | s | 2.40% | 7.8 | s | 2.59% | 13.2 | s |
| MWVC | nuMVC | 0.00% | 2.1 | m | 0.00% | 2.6 | m | 0.00% | 3.3 | m | 0.00% | 3.4 | m |
| | GOAL greedy | 0.26% | 2.4 | s | 2.03% | 8.3 | s | 3.84% | 26.3 | s | 3.00% | 57.6 | s |

Table 2 above lists test results of the model trained on six of the combinatorial optimization problems TSP, CVRP, CVRPTW, OP, KP, and MWVC. Table 2 demonstrates that, compared with others, similar performance can be reached on a variety of problems by the single model discussed herein.

The results of Table 2 were generated using 1 million training instances with node size 100. For TSP, CVRP, CVRPTW, and OP, training instances had nodes randomly placed in a unit square, and edge information given by the Euclidean distance between nodes. In the disclosed approach, node coordinates are not passed as features. For MWVC, the adjacency matrix is generated by an Erdos-Renyi process, while the KP problem has no edge information. Table 2 includes results on testing with the same number of nodes as during training, N=100, as well as results for generalizing to larger node numbers, N=200, 500, and 1000. All tests were performed on 10,000 instances. The reported performance numbers are average gap with respect to the oracles and the other approaches, which mostly give exact optima, so the gap indicated in Table 2 mostly is the true optimality gap.

As shown by the “time” columns in Table 2, the model discussed herein holds advantages when a quick solution is required. Heuristics, in contrast, often struggle to find a feasible solution within a short time budget. Hence, the availability of quick solutions renders the system very suitable in the context of robot trajectory and path planning. Training discussed herein may be performed by the training module. Adjustments discussed herein may be performed by the configuration module.

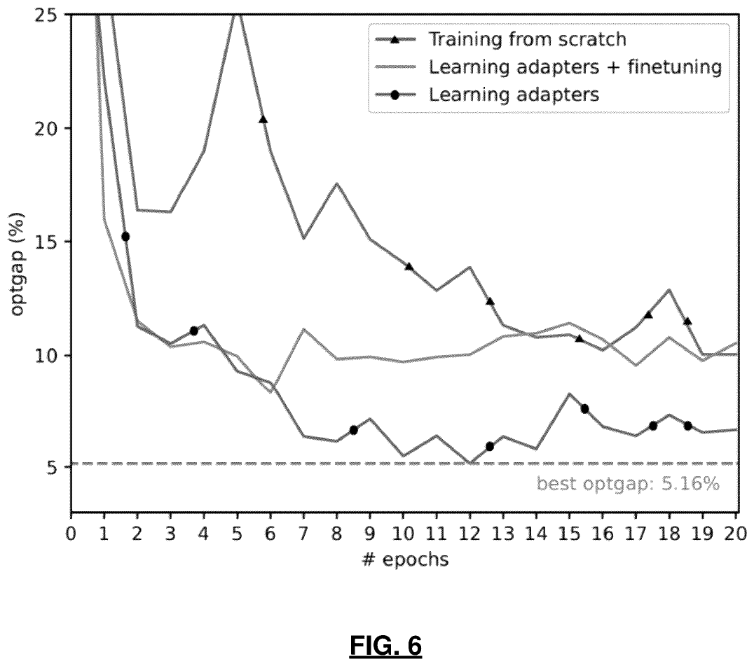

FIG. 6 shows results of studying generalization of the disclosed model to an unseen task. As unseen task, MCLP was selected, which falls under the category of covering location problems and is thus rather different from the other problems which are routing and graph problems. Firstly, a pipeline was trained from scratch for MCLP only. Secondly, a model was trained on the tasks of Table 1, but not on MCLP. Task-specific adapters 104-t, 106-t, 108-t for MCLP were then trained on a small set of 10,000 instances, either by keeping backbone neural network 110 fixed or by allowing backbone neural network 110 to be fine-tuned at the same time as the adapters 104-t, 106-t, 108-t are trained. As can be inferred from FIG. 6, with just 12 epochs of adapter training and without fine-tuning the backbone, the system reaches an optimality gap of 5.16% in only 18 minutes. As is evident in FIG. 6, fine-tuning backbone neural network 110 at the same time as training the adapters may not be beneficial. Further, training from scratch converges much slower, which demonstrates the synergistic effect of training the backbone neural network on multiple combinatorial optimization problems.

TABLE 3

| | | Generalization to asymetric routing problems (128 inst.) | | | | | | | | | | |
|---|---|---|---|---|---|---|---|---|---|---|---|---|
| | | N = 100 | | | N = 200 | | | N = 500 | | | N = 1000 | |
| | | opt. gap | time | | opt. gap | time | | opt. gap | time | | opt. gap | time |
| ATSP | LKH | 0.00% | 18 | m | 0.00% | 29 | s | 0.00% | 2.3 | m | 0.00% | 9.4 m |
| | MatNet greedy | 1.57% | 34 | s | 97.21% | 12.1 | s | — | — | | — | |
| | GOAL greedy | 1.63% | 2.8 | s | 1.55% | 8.6 | s | 4.29% | 26.1 | s | 8.09% | 1.1 m |
| ACVRP | HGS 1 m | 0.00% | 2.1 | h | 0.00% | 2.1 | h | 0.00% | 2.1 | h | 0.00% | 2.1 h |
| | HGS 1 s | 118/128 | 2.1 | m | 82/128 | 2.1 | m | 21/128 | 2.1 | m | 3/128 | 2.1 m |
| | GOAL greedy | 5.77% | 2.8 | s | 5.08% | 8.7 | s | 4.23% | 28.2 | s | 7.00% | 1.1 m |
| ACVRPTW | HGS 1 m | 0.00% | 2.1 | h | 0.00% | 2.1 | h | 0.00% | 2.1 | h | 0.00% | 2.1 h |
| | HGS 1 s | 116/128 | 2.1 | m | 9/128 | 2.1 | m | 1/128 | 2.1 | m | 0/128 | 2.1 m |
| | GOAL greedy | 8.41% | 3.2 | s | 12.68% | 10 | s | 15.00% | 29.6 | s | 15.38% | 1.1 m |

Table 3 lists results of the generalization of the systems to new instance types not seen during training, in particular, to instances types according to a non-Euclidean setting. To study performance on new instance types, instances of ATSP, ACVRP, and ACVRPTW were generated in which the edge features according to an Euclidean distance matrix were further augmented with a matrix of random values between 0 and 0.1. This approach ensures a form of correlation between the matrix values that may be the case in practice when e.g., the matrix represents travel times rather than distance. This implies that matrices are asymmetric and that, in particular, the triangle inequality is not satisfied. Other approaches for combinatorial optimization may focus on solving Euclidean versions of the problems based on node coordinates. This is however a significant limitation in applications in real-world scenarios, such as robotics.

In Table 3, a comparison is made whenever another approach is capable of dealing with such non-Euclidean configurations. MatNet (Kwon et al. 2022, cited above) can directly handle distance matrices and hence can be employed for non-Euclidean problems. However, as shown in Table 3, MatNet does not at all generalize to larger numbers of nodes.

As proven in Tables 2-3 and FIG. 6, the disclosed systems and methods exhibit excellent flexibility over a diverse set of combinatorial optimization problems at a performance which is in line with the existing task-specific models which are designed and trained for the specific tasks. In addition, the disclosed systems and methods allow much better generalization on problem size than other models.

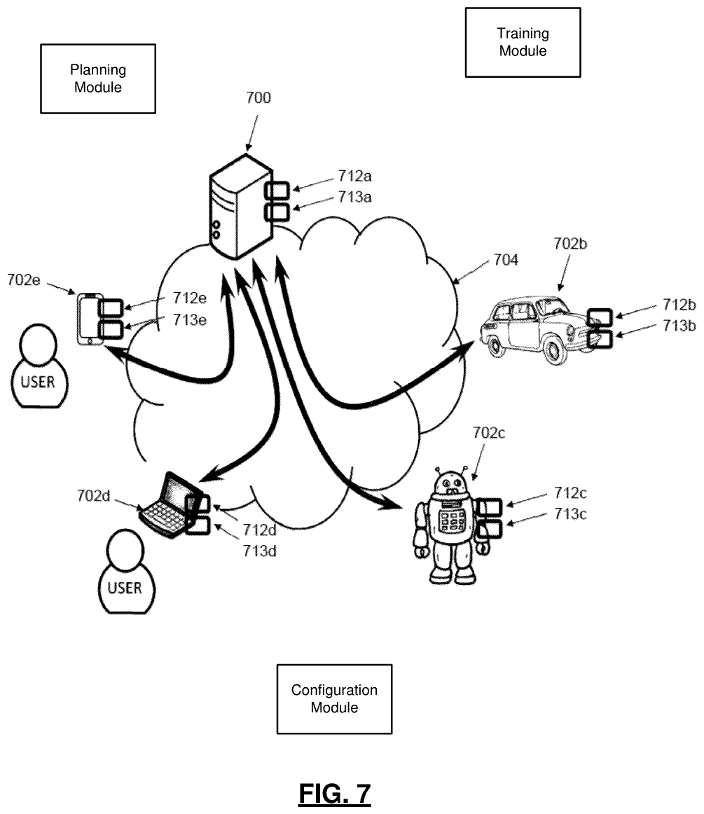

The above-mentioned systems, methods, and embodiments may be implemented within an architecture such as that illustrated in FIG. 7, which includes server 700 and one or more computing devices 702 that communicate over a network 704 (which may be wireless and/or wired), such as the Internet, for data exchange. Server 700 and the computing devices 702 each include one or more processors 712 and memory 713. Computing devices 702 may be any devices that communicate with server 700, including autonomous vehicle 702b, robot 702b, computer 702d, or mobile device (e.g., cell phone) 702e. More precisely, in an embodiment, the system according to the embodiments of FIGS. 1 and 2 may be implemented by server 700.

In particular, autonomous vehicle 702b or robot 702b (which may be fully or partially autonomous) may be configured to perform the method 500 and follow a route/path planned for it to navigate an environment and perform a task. Specifically, autonomous vehicle 702b or robot 702b may be located in an environment and may be tasked with visiting a plurality of specified positions and returning to an origin or moving to a predetermined location, e.g., for charging. Autonomous vehicle 702b or robot 702b may receive the backbone neural network 110 from server 700 and adjust adapters 104-t, 106-t, and 108-t according to task t. In some settings, the locations and the paths may involve three-dimensional coordinates (e.g., in a high-rise building).

Similarly, the disclosure may also be applied to an autonomous floating machine (e.g., submarine) or autonomous flying machine (e.g., drone or unmanned aerial vehicle). Accordingly, such autonomous machines (which may be fully or partially autonomous) may be configured to receive the backbone neural network 110 from server 700 and adjust adapters 104-t, 106-t, and 108-t according to task t. In this setting, the locations and the paths involve three-dimensional coordinates. The autonomous machines include a plurality of sensors, such as position sensors and other types of sensors.

Further, an autonomous machine, such as vehicle 702b, robot 702b, the autonomous floating machine or the autonomous flying machine may have a predetermined maximum payload. The disclosed methods and systems may in particular be applied when vehicle 702b, robot 702b, the autonomous floating machine or the autonomous flying machine is tasked with transporting specific payloads to specific positions, transporting specific payloads to specific positions within specific time windows, or collecting payloads from specific positions. The disclosed methods and systems may also be applied at the vehicle 902b or robot 902b for selecting a robot payload from a set of payloads to maximize a metric value of the robot payload.

In other examples, the disclosed methods and systems may be applied when the autonomous machines (e.g., vehicle 702b, robot 702c, floating machine or flying machine) are part of a fleet of autonomous machines. The fleet of autonomous machines may be tasked with covering specific positions such that each position is within a radius of coverage of at least one of the autonomous machines.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A method for robot navigation, the method comprising:
receiving a backbone neural network, the backbone neural network trained to solve a set of autonomous navigation tasks including a first autonomous navigation task, wherein the first autonomous navigation task includes optimizing a first path visiting a first number of first locations when considering first path costs;
receiving a second autonomous navigation task, wherein the second autonomous navigation task includes optimizing a second path visiting a second number of second locations when considering second path costs, wherein the second locations are locations in an environment of an autonomous machine, wherein the second number is different from the first number;
configuring adapter layers for the backbone neural network for forming a neural network pipeline, wherein the adapter layers comprise a node adapter, an edge adapter and an output adapter, wherein the node adapter is configured to receive the second locations and provide a representation of the second locations to the backbone neural network, wherein the edge adapter is configured to receive the second path costs and provide a representation of the second path costs to the backbone neural network, and wherein the output adapter is configured to receive an intermediate solution of the second autonomous navigation task generated by the backbone neural network and to generating an output of the pipeline; and
feeding the second locations and the second path costs to the neural network pipeline and determining a path for the autonomous machine based on the output.

2. The method of claim 1, further comprising instructing the autonomous machine to move in the environment in accordance with the determined path.

3. The method of claim 1 further comprising, by the autonomous machine, autonomously following the path and navigating the environment.

4. The method of claim 1, wherein the feeding the second locations and the second path costs to the neural network pipeline comprises iterating the neural network pipeline for the second number of times, wherein at each iteration the output adapter selects a next location of the second locations.

5. The method of claim 4, wherein the instructing the autonomous machine to move in the environment in accordance with the determined path includes, in response to completing a first iteration of the neural network pipeline, instructing the autonomous machine to start moving to the next location selected in the first iteration of the neural network pipeline.

6. The method of claim 1, wherein the first path costs are according to an Euclidean metric for distances between the first locations, wherein the second path costs do not conform to any Euclidean metric.

7. The method of claim 1,
wherein the first autonomous navigation task is an instance of a first combinatorial optimization problem, and wherein the second autonomous navigation task is an instance of a second combinatorial optimization problem.

8. The method of claim 7, wherein the second combinatorial optimization problem is different from the first combinatorial optimization problem.

9. The method of claim 8, wherein the configuring adapter layers further comprises:
performing few-shot training of the node adapter, the edge adapter, and the output adapter and adjusting the neural network pipeline based on solving the second autonomous navigation task.

10. The method of claim 9, further comprising freezing the parameters of the backbone neural network during the performing the few-shot training.

11. The method of claim 9, wherein the performing the few-shot training is based on imitation learning based on solving instances of the second combinatorial optimization problem.

12. The method of claim 9, wherein the performing the few-shot training is based on reinforcement learning.

13. The method of claim 7, wherein the second combinatorial optimization problem is the Maximum Coverage Location Problem.

14. A system for robot navigation, the system comprising:
one or more processors; and
memory including code that, when executed by the one or more processors, perform to:
receive a backbone neural network, the backbone neural network trained to solve a set of autonomous navigation tasks including a first autonomous navigation task, wherein the first autonomous navigation task includes optimizing a first path visiting a first number of first locations when considering first path costs;
receive a second autonomous navigation task, wherein the second autonomous navigation task includes optimizing a second path visiting a second number of second locations when considering second path costs, wherein the second locations are locations in an environment of an autonomous machine, wherein the second number is different from the first number;
configure adapter layers for the backbone neural network for forming a neural network pipeline, wherein the adapter layers comprise a node adapter, an edge adapter and an output adapter, wherein the node adapter is configured to receive the second locations and provide a representation of the second locations to the backbone neural network, wherein the edge adapter is configured to receive the second path costs and provide a representation of the second path costs to the backbone neural network, and wherein the output adapter is configured to receive an intermediate solution of the second autonomous navigation task generated by the backbone neural network and to generating an output of the pipeline; and
feed the second locations and the second path costs to the neural network pipeline and determine a path for the autonomous machine based on the output.

15. The system of claim 14 further comprising the autonomous machine, wherein the autonomous machine is configured to autonomously follow the path and navigate the environment.

16. A method of training neural network pipelines for robot navigation, the method comprising:
generating a plurality of training data sets, wherein each training data set corresponds to an autonomous navigation task of a plurality of autonomous navigation tasks, wherein the generating a training data set of the plurality of training data sets comprises:
generating a number of training samples of the respective autonomous navigation task; and
solving the training samples for the respective autonomous navigation task; and
training a plurality of neural network pipelines with the plurality of training data sets, wherein all neural network pipelines share a backbone neural network, wherein each neural network pipeline further comprises a task-specific node adapter, a task-specific edge adapter, and a task-specific output adapter.

17. The method of claim 16, wherein the backbone neural network comprises a predetermined number of layers, wherein each layer comprises a mixed-score self-attention block.

18. The method of claim 17, wherein the mixed-score self-attention block is configured to combine a node representation, a mask, and an edge representation.

19. The method of claim 18, wherein the mask is provided by a masking block and the edge representation is provided by the task-specific edge adapter.

20. An autonomous machine comprising:
position sensors;
one or more propulsion devices;
one or more processors; and
memory that stores a plurality of trained neural network pipelines corresponding to a plurality of autonomous navigation tasks, wherein the trained neural network pipelines comprise a shared backbone neural network and task-specific adapter layers.

21. The autonomous machine of claim 20, wherein the autonomous navigation tasks include the autonomous machine autonomously traveling from a starting location, visiting a plurality of locations, and ending at an ending location.

22. The autonomous machine of claim 20 wherein the autonomous navigation tasks further include one or more of:
delivering payloads to one or more locations;
delivering the payloads to one or more locations within a predetermined time window; and
selecting one or more payloads from a plurality of payloads based on maximizing a metric value of the one or more payloads while taking into account a maximum load of the autonomous machine.
